(19) United States
(12) Patent Application Publication
(10) Pub. No.: US 2008/0044722 A1
(43) Pub. Date: Feb. 21, 2008

(54) FUEL CELL WITH CARBON NANOTUBE DIFFUSION ELEMENT AND METHODS OF MANUFACTURE AND USE

(75) Inventors: Habib Mohamadinejad, Bartlett, TN (US); Kangning Liang, Bartlet, TN (US)

Correspondence Address: DARBY & DARBY P.C., P.O. BOX 770, Church Street Station, New York, NY, 10008-0770, US

(73) Assignee: Brother International Corporation, Bridgewater, NJ (US)

(21) Appl. No.: 11/466,081

(22) Filed: Aug. 21, 2006

(51) Int. Cl. H01M 4/94; H01M 8/10; H01M 4/88; B05D 5/12

(52) U.S. Cl. 429/44; 429/30; 502/101; 427/115; 429/13

(57) ABSTRACT

A fuel cell includes a first current collector; a second current collector; an ion exchange membrane disposed between the first and second current collectors; a diffusion element; and catalyst. The diffusion element is disposed between the first current collector and the ion exchange membrane. The diffusion element includes carbon nanotubes and the catalyst is disposed on a portion of the carbon nanotubes to form a catalyst layer.

### FIELD

The invention is directed to fuel cells and methods of manufacture and use of the fuel cells. The invention is also directed to fuel cells with a diffusion element that contains carbon nanotubes, as well as the diffusion element itself and methods of manufacture and use of the fuel cells and diffusion elements.

### BACKGROUND

A carbon nanotube (CNT) can be described as a honeycomb lattice rolled into a cylinder. The carbon nanotube typically has a high aspect ratio and, therefore, possesses a high ratio of surface area to volume. Carbon nanotubes possess unique mechanical, thermal, and electrical properties. For example, carbon nanotubes can be highly conductive.

Carbon nanotubes have high mechanical strength by themselves. The interactions between carbon nanotubes produce non-chemical bond forces, such as Van der Waals forces, to maintain bundles of carbon nanotubes. To increase these forces, a close proximity between adjacent carbon nanotubes is desirable. One method for achieving this close proximity is the growth of dense groups of carbon nanotubes on a substrate.

Fuel cells have been developed that utilize hydrogen and oxygen (or other fuels) to generate electricity. Fuel cells have been proposed as an alternative to the combustion of fossil fuels, as well as for use in other applications. There is considerable effort being undertaken to improve the efficiency, cost, reliability, size, and output of fuel cells.

### BRIEF SUMMARY

One embodiment is a fuel cell including a first current collector; a second current collector; an ion exchange membrane disposed between the first and second current collectors; a diffusion element; and catalyst. The diffusion element is disposed between the first current collector and the ion exchange membrane. The diffusion element includes carbon nanotubes and the catalyst is disposed on a portion of the carbon nanotubes to form a catalyst layer.

Another embodiment is a method of making a fuel cell including forming a diffusion element having carbon nanotubes and forming the fuel cell with the diffusion element disposed between a current collector and an ion exchange membrane.

Yet another embodiment is a method of using a fuel cell including providing a first fuel to a first section of the fuel cell and providing a second fuel to a second section of the fuel cell. An ion exchange membrane separates the first section of the fuel cell from the second section. The first fuel diffuses towards the ion exchange membrane through a diffusion element having a plurality of carbon nanotubes. The first fuel reacts at a catalyst layer disposed between the diffusion element and the ion exchange membrane to form an ionic species. The ionic species is transported across the ion exchange membrane to the second section of the fuel cell and reacts with the second fuel.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic cross-sectional view of a fuel cell, according to the invention; and

FIGS. 2A-2G illustrate steps in part of the process of the formation of a diffusion element for a fuel cell, according to the invention.

### DETAILED DESCRIPTION

The invention is directed to fuel cells and methods of manufacture and use of the fuel cells. The invention is also directed to fuel cells with a diffusion element that contains carbon nanotubes, as well as the diffusion element itself and methods of manufacture and use of the fuel cells and diffusion elements.

A fuel cell can be formed using carbon nanotubes in a diffusion element through which fuel travels to a catalyst. For example, the fuel cell can utilize a hydrogen-containing fuel and an oxygen-containing fuel where each fuel is provided to a different section of the fuel cell and the two sections are separated by an ion exchange membrane. One fuel (e.g., the hydrogen-containing fuel) travels through the diffusion element and then reacts in the presence of a catalyst to produce ions (e.g., protons) that transport across the ion exchange membrane to react with the second fuel. These reactions generate and consume electrons, respectively, resulting in the generation of an electrical current that can be provided to an external circuit.

A diffusion element, containing carbon nanotubes, is disposed between the fuel inlet and the catalyst for one or both sections of the fuel cell. Optionally, the carbon nanotubes are disposed on a diffusion layer, such as an amorphous carbon layer. The diffusion element facilitates efficient transport of the fuel to the catalyst by spreading the fuel over a larger area. Carbon nanotubes can be used to provide a diffusion element with desirable properties. The carbon nanotubes are highly conductive and can carry the electrons away from the catalyst. In addition, the carbon nanotubes have relatively high surface area. The catalyst can be disposed on a portion of the carbon nanotubes to produce a catalyst layer. The high surface area can result in a more efficient catalytic reaction than arrangements where the catalyst is disposed on a relatively flat surface.

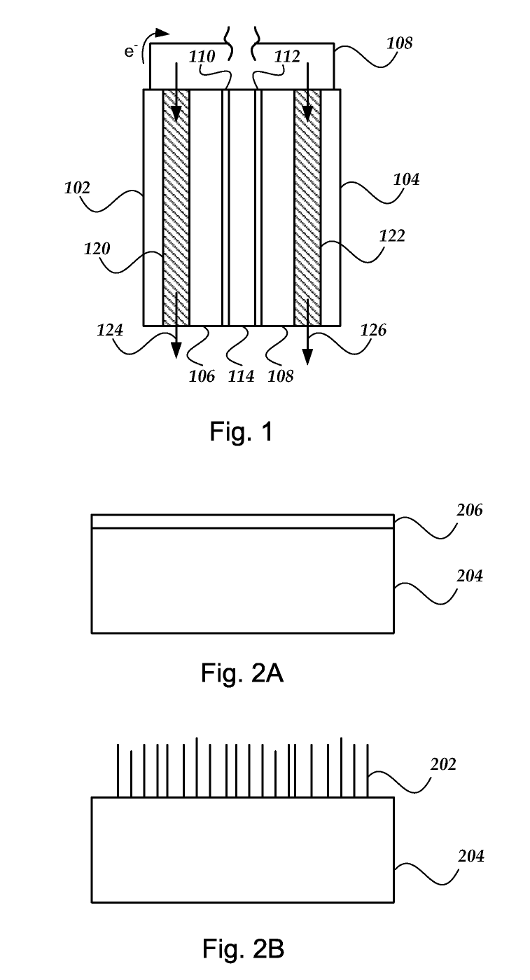

FIG. 1 illustrates one embodiment of a fuel cell 100 coupled to an external circuit 118. The fuel cell includes two current collectors 102, 104 that also define channels 120, 122 for passage of a first fuel 124 and a second fuel 126, respectively, through the fuel cell. The fuel cell 100 also includes two diffusion elements 106, 108; two catalyst layers 110, 112; and an ion exchange membrane 114. A variety of different fuels can be used in the fuel cell. In many embodiments, one fuel contains hydrogen and another fuel contains oxygen. As one example, the two fuels 124, 126 can be hydrogen and oxygen gas. In this embodiment, the electrons can be removed from the hydrogen molecule at the catalyst layer 110 to leave hydrogen ions (i.e., protons.) The protons can then move across the ion exchange membrane 114 (e.g., a proton exchange membrane) to react at the catalyst layer 112 with the oxygen gas to form water. In this process, electrons are generated on the hydrogen side of the fuel cell and consumed at the oxygen side of the fuel cell with the result that a current flows through the current collectors 102, 104 and the external circuit 118. The electrochemical reactions correspond to:

2H₂→4H⁺+4e⁻ (oxidation half reaction)

O₂+4H⁺+4e⁻→2H₂O (reduction half reaction)

2H₂+O₂→2H₂O (net reaction)

In another embodiment, the hydrogen-containing fuel is ethylene, methanol or another compound from which hydrogen ions can be extracted (such as other alcohols.) As one example, methanol can be combined with water to form the hydrogen-containing fuel. Carbon dioxide and water are the typical byproducts of this fuel cell. The electrochemical reactions correspond to:

2CH₃OH+2H₂O→2CO₂+12H⁺+12e⁻ (oxidation half reaction)

3O₂+12H⁺+12e⁻→6H₂O (reduction half reaction)

2CH₃OH+3O₂→2CO₂+4H₂O (net reaction)

The current collectors 102, 104 of the fuel cell 100 can be made of any suitable conductive material, such as a metal or alloy or graphite. Examples of suitable materials include, but are not limited to, steel, cobalt, and titanium. Generally, at least a portion of the current collectors 102, 104 is in contact with the respective diffusion elements 106, 108 to permit the flow of electrons between the current collectors and diffusion elements. Typically, however, the fuel also flows between the current collector and diffusion element. The current collector (or diffusion element) can be shaped to allow the fuel flow while still maintaining contact. For example, the current collectors 102, 104 (or diffusion elements 106, 108) can be formed with one or more channels 120, 122 (preferably, a plurality of channels) through the current collector (or diffusion element) for passage of the fuel 124, 126 while maintaining contact of a portion of the current collectors 102, 104 with the respective diffusion elements 106, 108 to allow current to flow. The current collectors 102, 104 provide the connection points to the external circuit 118.

The ion exchange membrane 114 permits the flow of ions (e.g., hydrogen ions/protons) across the membrane while resisting (and, preferably, preventing) the flow of other species (particularly, the two fuels) across the membrane. One example of a suitable membrane is a NAFION™ membrane available from DuPont. This membrane provides good transport for protons but resists the flow of hydrogen and oxygen gas through the membrane. Other membranes that perform the desired function can also be used. The thickness of the membrane can be selected to provide a desired flow of ions and/or a desired resistance to the flow of other species, such as the fuels across the membrane. As an example, the ion exchange membrane can have a thickness in the range of 40 □m to 90 □m.

The catalyst layers 110, 112 contain catalytic material that catalyzes the desired reactions of the fuel cell. As an example, the catalysts layers of a hydrogen/oxygen fuel cell can both be made of platinum metal, for example, black platinum. Platinum catalyzes both the oxidation of hydrogen and the combination of protons with oxygen to form water. Other suitable catalysts can be used such as 50/50 platinum/ruthenium. The two catalyst layers 110, 112 can include the same or different catalysts. The selection of catalyst can depend on a variety of factors including, for example, the reaction to be catalyzed, the presence or absence of side reactions, the presence of contaminants in the fuel cell or in the fuels that may poison the catalyst, the desired reaction rate, other materials in the fuel cell, the manufacturing process, etc. In many conventional fuel cells and in some embodiments of the present invention, the catalyst layer is disposed on the ion exchange membrane or on another porous substrate.

The diffusion elements 106, 108 manage the flow of fuel to the catalyst layers 110, 112 to increase the efficiency of the fuel cell. In at least some instances, the diffusion elements 106, 108 facilitate the fuel flow so that the fuel spreads out and makes contact with most of, and preferably substantially all of, the surface of the respective catalyst layer. In conventional fuel cells, amorphous carbon, often disposed on some porous substrate, is used as the diffusion element.

One or both of the diffusion elements 106, 108 can be formed using carbon nanotubes instead of, or in addition to, amorphous carbon. Preferably, the carbon nanotubes are generally vertically aligned (i.e., aligned generally perpendicular to the current collector and ion exchange membrane.) The density of the carbon nanotubes, as well as the length of the nanotubes, can be selected to provide a desired rate of fuel flow. As an example, the density of carbon nanotubes in the diffusion element can be in the range of 1×10⁸/cm² to 5×10⁸/cm², preferably in the range of 2×10⁸/cm² to 3×10⁸/cm². In at least some embodiments, the carbon nanotubes have an average length of at least 0.1 mm and, preferably, in the range of 0.1 to 1 mm.

In addition to their other properties, the carbon nanotubes have relatively high electrical conductivity. In at least some instances, the electrical conductivity of carbon nanotubes can be higher than that of amorphous carbon resulting in lower ohmic resistance in the diffusion element and in the fuel cell, in general.

In addition, the carbon nanotubes have a high aspect ratio (i.e., the ratio of length to diameter of the tubes.) For example, at least some carbon nanotubes have aspect ratios of at least 3000 and preferably in the range of 3000 to 30,000 In at least some embodiments, the carbon nanotubes have an average diameter in the range of 10 nm to 50 nm. The high aspect ratio provides the carbon nanotubes with relatively high surface area. One side of the carbon nanotube diffusion element can be coated with the desired catalyst (e.g., black platinum) to form the catalyst layer on the diffusion element.

For example, the diffusion element 106 can be formed of generally vertically aligned carbon nanotubes. The catalyst layer 110 can then be formed by depositing the catalyst onto one surface of the diffusion element. The deposited catalyst will typically extend into the diffusion element 106 and coat the proximal regions of the carbon nanotubes for some distance depending on a variety of factors including, for example, the density of the carbon nanotubes; the particular catalyst chosen; the deposition method; deposition parameters such as time, temperature, concentration, and the like. In some embodiments, the catalyst extends at least 50 to 75% of the nanotube length into the diffusion element. The portion of the diffusion element that contains the catalyst forms the catalyst layer 110. Such a catalyst layer can be particularly effective because of the relatively high surface area of the catalyst-coated carbon nanotubes.

Optionally, the diffusion element can also be coupled to the ion exchange membrane by partially embedding the ends of the carbon nanotubes into the membrane. This arrangement can also be used to remove the diffusion element from the substrate upon which it was formed.

In one embodiment, the diffusion element contains carbon nanotubes that are formed or otherwise disposed on or adjacent to a diffusion layer, such as an amorphous carbon diffusion layer. Such an arrangement may provide a larger surface area for deposition of the catalyst than the diffusion layer itself. In this embodiment, the carbon nanotubes of the diffusion element may act primarily as a substrate for the catalyst.

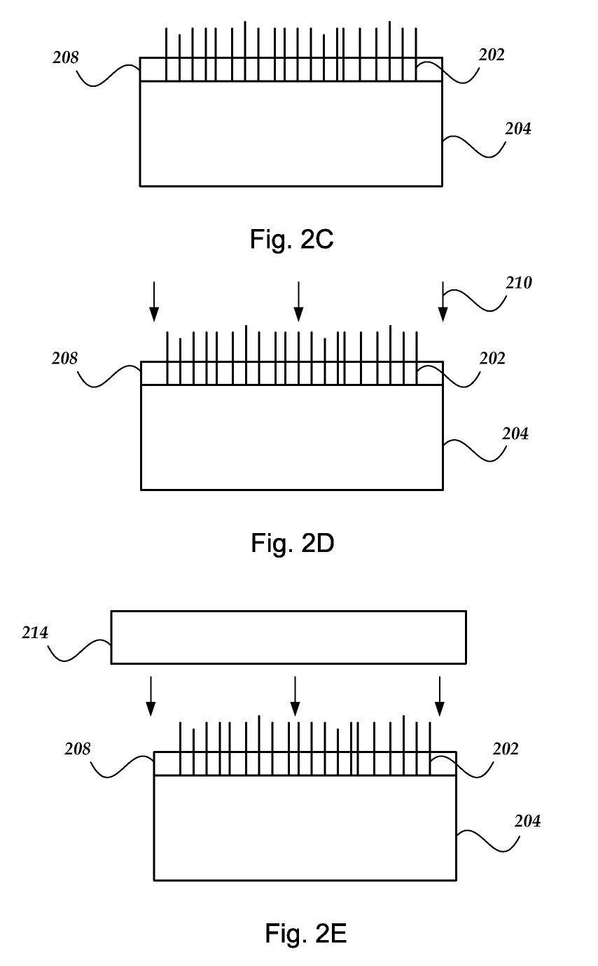

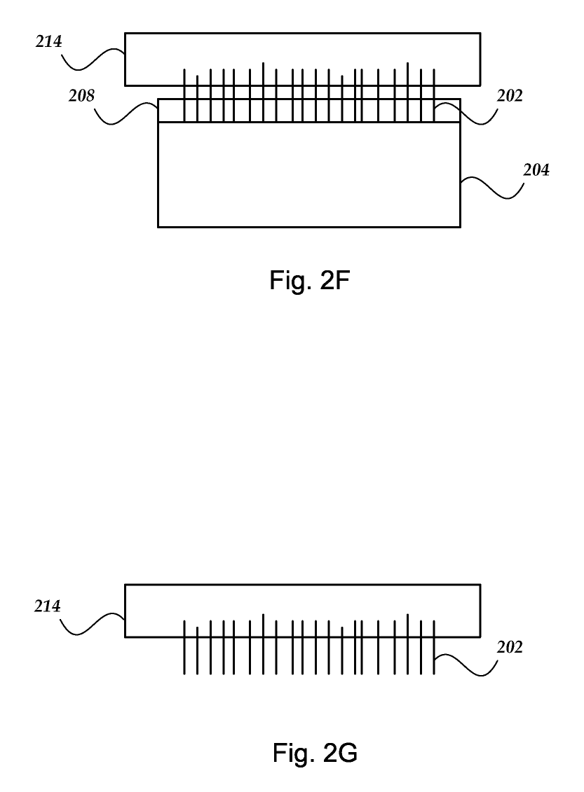

FIGS. 2A-G illustrate a portion of one embodiment of a process to form a carbon nanotube diffusion element. First, carbon nanotubes 202 are formed on a substrate 204 as illustrated in FIG. 2A-2B. There are many method that can be used to form carbon nanotubes and generally any of these methods is suitable. The carbon nanotubes are preferably formed so that they are aligned perpendicular to the surface of the substrate. In addition, the carbon nanotubes are, preferably, densely distributed on the substrate. For example, the distribution of the carbon nanotubes covers at least 10 to 50% of the surface of the substrate and, more preferably, at least 20%.

In one example of a method for the formation of carbon nanotubes, a silicon substrate 204 is prepared. Other suitable substrates include, but are not limited to, quartz, ceramic, and glass substrates. As illustrated in FIG. 2A, the top of the substrate 204 is coated with a thin layer 206 of a catalyst suitable for the preparation of the carbon nanotubes. Examples of suitable catalysts include, but are not limited to, iron, cobalt, nickel, platinum, palladium, molybdenum, and combinations thereof. The catalyst layer can be formed by any process including chemical vapor deposition (CVD) and physical vapor deposition (PVD) processes, such as evaporation, sputtering, and the like. In one embodiment, the thickness of the catalyst layer is about 2 to 10 nm.

The carbon nanotubes 202 are then formed on the substrate 204 and in the presence of the catalyst layer (not shown), as illustrated in FIG. 2B. The nanotubes can be formed using any method including chemical vapor deposition (CVD) and plasma-enhanced chemical vapor deposition (PECVD) techniques. In one CVD process, hydrogen and ethylene gases are provided in a furnace heated to a temperature in the range of 650 to 1000° C. (for example, around 700° C.) The ratio of the gases can be selected to obtain desired carbon nanotube properties and growth rates. For example the gases can range from pure ethylene to 1:3 ethylene:hydrogen ratio. In at least some embodiments, the ratio of ethylene to hydrogen is in the range of 7:1 to 1:3. The growth time can range from 1 minute to 60 minutes or more. Variations in temperature, growth time, and gas ratio can change nanotube parameters such as, for example, diameter, height, conformation, etc. It will be understood that this is one example of a method of preparing carbon nanotubes. Other methods of preparing carbon nanotube can be used including, for example, methods utilizing different gases and gas ratios, different temperature, and different growth times.

Generally, the diameter and length of the carbon nanotubes depend on the process parameters (e.g., temperature, time, ratio of gases, etc.) and gases used in growing the nanotubes. In addition, some nanotube formation techniques grow single-walled nanotubes and others techniques grow multi-walled nanotubes. In one example, multi-walled carbon nanotubes were grown at 700° C. for 25 minutes on a silicon substrate with an iron catalyst layer. Different mixtures of gases were used including a first mixture containing 100 sccm (standard cubic centimeters per minute) hydrogen and 690 sccm ethylene and a second mixture containing 400 sccm hydrogen, 400 sccm ethylene, and 400 sccm argon. The resulting carbon nanotubes had an average height of about 150 micrometers and a diameter in the range of 20 to 40 nm. These carbon nanotubes can be removed from the substrate and used in a diffusion element.

In one example of a method of removing the carbon nanotubes, a polymer composition 208 is provided over the nanotubes after the carbon nanotubes 202 are grown, as illustrated in FIG. 2C. This polymer composition includes at least a polymer and, optionally, a solvent. In some instances, the polymer may act as its own solvent. In other instances a solvent is provided with the polymer. Any method can be used for depositing the polymer composition on the carbon nanotubes including dip coating, spin coating, knife coating, and the like. The solvent preferably does not substantially solvate the carbon nanotubes or the substrate. Preferably, the polymer composition is sufficiently fluidic to permit uniform coverage over the substrate.

Any polymer can be used in the polymer composition 208. Preferably, the polymer is soft and flexible, not brittle, upon removal of any solvent. Polymers with such characteristics often have a glass transition temperature that is no more than 25° C. or room temperature. More preferably, the polymer is glassy, tacky, and soft at room temperature or 25° C., upon removal of the solvent. In addition, the polymer is preferably soluble in water or an organic solvent that does not solvate the carbon nanotubes. Examples of suitable polymers include polyvinyl methyl ether (PVME), NAFION™. As an example, 1-3 ml of a 1.2% PVME aqueous solution can be disposed on carbon nanotubes disposed on a 1.5×2.5 inch (about 3.8×6.3 cm) substrate.

It will be understood that the term “polymer” includes, but is not limited, to mixtures or other combinations of polymeric materials, as well as copolymers and the like. In addition to the polymer and solvent, the polymer composition can also include one or more additives, such as surfactants, plasticizers, antioxidants, filler, tackifiers, and the like.

Once the polymer composition 208 is disposed over the carbon nanotubes 202, the solvent, if present, is at least partially removed to produce a solid composition 210 of the carbon nanotubes and polymer. Preferably, substantially all of the solvent is removed. Preferably, once the solvent is removed a top portion of the carbon nanotubes 202 extends out of the polymer composition.

Optionally, once the polymer composition 208 is formed (or, alternatively, prior to coating the polymer composition over the carbon nanotubes), the catalyst 210 can be disposed on the carbon nanotubes 202, as illustrated in FIG. 2D. Any method can be used to coat the catalyst on the carbon nanotubes including, for example, physical vapor deposition (e.g., electron beam evaporation, other evaporation techniques, or sputtering) or chemical vapor deposition. In some instances, the upper surface of the polymer composition 208 may act as a stop to prevent or hinder deposition of the catalyst on portions of the carbon nanotubes encapsulated in the polymer composition. In other instances, the depth of catalyst penetration into the carbon nanotube structure can be controlled by process parameters (e.g., time, temperature, evaporation or sputtering rate, and/or carbon nanotube density) during the deposition. In one embodiment, the catalyst forms micro-sized regions in the range of 5-20 nanometers in diameter.

Once the polymer composition is formed 208 and, optionally, the catalyst 210 is disposed on the carbon nanotubes 202, the ion exchange membrane 214 (or another polymer film or membrane) can be brought into contact with the exposed ends of the carbon nanotubes, as illustrated in FIG. 2E. The ends of the carbon nanotubes can then be embedded into the ion exchange membrane 214, as illustrated in FIG. 2F. For example, pressure can be applied to the ion exchange membrane 214 or the substrate 204 to push the ends of the carbon nanotubes into the ion exchange membrane. Preferably, the force applied is sufficient to embed the carbon nanotube ends to a depth that allows the carbon nanotubes to be removed and separated from the substrate 204, as illustrated in FIG. 2G.

The polymer composition 208 is removed prior to, or after, separating the carbon nanotubes from the substrate 204. Removal of the carbon nanotubes can be accomplished by a variety of methods including, for example, treating the polymer composition with a solvent that solvates the polymer and not the carbon nanotubes or the ion exchange membrane.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A fuel cell, comprising:
a first current collector;
a second current collector;
an ion exchange membrane disposed between the first and second current collectors;
a diffusion element disposed between the first current collector and the ion exchange membrane, wherein the diffusion element is configured and arranged to receive a first fuel and allow diffusion of the first fuel towards the ion exchange membrane, the diffusion element comprising carbon nanotubes; and
a catalyst disposed on a portion of the carbon nanotubes to form a catalyst layer.

2. The fuel cell of claim 1, wherein the fuel cell is configured and arranged to utilize a hydrogen-containing fuel and an oxygen-containing fuel.

3. The fuel cell of claim 1, wherein the ion exchange membrane comprises a polymeric membrane.

4. The fuel cell of claim 3, wherein a portion of one or more of the carbon nanotubes of the diffusion element are imbedded in the polymeric membrane.

5. The fuel cell of claim 1, wherein the carbon nanotubes are generally vertically aligned perpendicular to the first current collector.

6. The fuel cell of claim 1, further comprising a second diffusion element disposed between the second current collector and the ion exchange membrane.

7. The fuel cell of claim 6, wherein the second diffusion element comprises carbon nanotubes.

8. The fuel cell of claim 1, wherein the diffusion layer comprises a diffusion layer with the carbon nanotubes disposed on or adjacent to the diffusion layer.

9. A method of making a fuel cell, the method comprising:
forming a diffusion element comprising a plurality of carbon nanotubes; and
forming a fuel cell with the diffusion element disposed between a current collector and an ion exchange membrane.

10. The method of claim 9, wherein forming a diffusion element comprises forming a plurality of carbon nanotubes on a substrate.

11. The method of claim 10, wherein forming a diffusion element further comprises transferring the carbon nanotubes from the substrate to the ion exchange membrane.

12. The method of claim 11, wherein forming a diffusion element further comprises disposing a polymer composition around a portion of the carbon nanotubes to facilitate transferring the carbon nanotubes from the substrate to the ion exchange membrane while maintaining an alignment of the carbon nanotubes.

13. The method of claim 9, further comprising depositing a catalyst material on portions of the carbon nanotubes proximate to a first surface of the diffusion element.

14. The method of claim 13, wherein depositing the catalyst material comprises evaporating the catalyst material on the portions of the carbon nanotubes.

15. The method of claim 9, wherein forming the diffusion element comprises embedding ends of at least a portion of the plurality of carbon nanotubes in the ion exchange membrane.

16. A method of using a fuel cell, the method comprising:
providing a first fuel to a first section of the fuel cell and providing a second fuel to a second section of the fuel cell, wherein an ion exchange membrane separates the first section of the fuel cell from the second section;
diffusing the first fuel towards the ion exchange membrane through a diffusion element comprising a plurality of carbon nanotubes;
reacting the first fuel at a catalyst layer disposed between the diffusion element and the ion exchange membrane to form an ionic species;
transporting the ionic species across the ion exchange membrane to the second section of the fuel cell; and
reacting the ionic species with the second fuel.

17. The method of claim 16, wherein the catalyst layer is disposed on portions of the plurality of carbon nanotubes of the diffusion element.

18. The method of claim 16, wherein reacting the first fuel at the catalyst layer comprises reacting the first fuel at the catalyst layer to form protons as the ionic species.

19. The method of claim 16, wherein the carbon nanotubes are generally aligned perpendicular to the ion exchange membrane.

20. The method of claim 16, wherein a portion of the carbon nanotubes are partially embedded in the ion exchange membrane.
